(19) United States
(12) Patent Application Publication
(10) Pub. No.: US 2008/0139109 A1
(43) Pub. Date: Jun. 12, 2008

(54) PORTABLE DEVICE WITH COMBINED BROADCAST AND WEB RADIO

(76) Inventor: Carl Christian EWERTZ, Bunkeflostrand (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/608,899

(22) Filed: Dec. 11, 2006

(51) Int. Cl. H04H 20/71

(52) U.S. Cl. 455/3.01

(57) ABSTRACT

The invention relates to a combined broadcast and web radio in a portable device. The device is arranged to switch automatically between broadcast radio and web accessed radio in dependence of received signal strength and quality. The device comprises: a radio receiver tunable to broadcast radio frequencies; a web radio interface adapted to access radio stations through a global communications network; a control unit capable of controlling the radio receiver and the web radio interface and adapted to monitor received signal strength on the radio receiver. The control unit is adapted to switch the device from a broadcast radio reception mode to a web radio reception mode, if the monitored received signal strength of the broadcast radio drops below a first limit.

### FIELD OF THE INVENTION

The present invention relates to a combined broadcast and web radio in a portable device. The device is arranged to switch automatically between broadcast radio and web accessed radio in dependence of received signal strength and quality.

### BACKGROUND

Today many mobile telephones and portable devices include a broadcast (FM) radio receiver together with other main or subsidiary functions. The user may be listening to a radio station when the user is moving with the device. The reception varies with the location and the signal from the broadcasting station may become too weak. The reception is gradually worse and will finally disappear. This problem is partially overcome by means of the RDS (Radio Data System). With this system, the radio receiver is arranged to automatically find another frequency, transmitting the same program from another transmitter location resulting in better reception. However, some stations/programs are only available locally or regionally.

On the other hand, more and more broadcast radio stations are also providing their programs by means of streaming over a global communications system, such as the Internet, so called web (accessed) radio. If access to the Internet is available, such a station may be received anywhere. The drawback with web radio is that web access may be more expensive and the web interface more power consuming. Broadcast radio is free and normally less power consuming.

The published US patent application 2004/0029525 discloses systems and methods for accessing Internet audio data streams suitable for use in broadcast radio mode or web accessed mode in stand-alone mobile devices. The document is focused on an effective way of organizing and categorizing web broadcasts of interest to the user.

The published US patent application 2002/0072326 discloses a stationary radio apparatus adapted to receive web radio broadcasts. The apparatus is adapted to allow a user to receive web radio in a manner similar to the ease and low cost with which a user receives a regular radio broadcast.

In view of advantages and disadvantages with broadcast radio and web access radio, respectively, there is a need for a device provided with both systems and in which switching between the systems is arranged automatically.

### SUMMARY OF THE INVENTION

An object of the present invention is to provide a portable device with combined broadcast and web radio, in which broadcast radio is used when possible and automatic switching is performed to web radio when the quality drops or broadcast radio is no longer available.

Another object of the present invention is to provide a combined broadcast radio and web radio in which the web radio is automatically switched to broadcast radio when possible in dependence of received signal strength.

Still a further object of the present invention is to provide a portable device with a combined broadcast and web radio, in which the broadcast radio receiver uses RDS and the web radio is incorporated in the RDS function.

The invention provides a portable device comprising: a radio receiver tunable to broadcast radio frequencies; a web radio interface adapted to access radio stations through a global communications network; a control unit capable of controlling the radio receiver and the web radio interface and adapted to monitor received signal strength on the radio receiver; wherein the control unit is adapted to switch the device from a broadcast radio reception mode to a web radio reception mode, if the monitored received signal strength of the broadcast radio drops below a first limit.

In one embodiment, if the monitored received signal strength drops below said first limit, the control unit is adapted to perform a search for a better broadcast radio channel frequency than an original frequency with a program matching the broadcast radio original frequency, before switching the device from a broadcast radio reception mode to a web radio reception mode.

Suitably, the device further comprises storage means for receiving and storing a list of alternative frequencies; and the control unit is adapted to perform next search using the list of alternative frequencies.

Suitably, the control unit is adapted to use a url address for web access in the web radio reception mode, the url being included in the list of alternative frequencies or the url being included as part of the Radio Text (RT) defined within the RDS standard.

Preferably, the control unit is adapted to switch the device from a web radio reception mode to a broadcast radio reception mode, if the monitored received signal strength of the broadcast radio rises above a second limit.

Preferably, the control unit is adapted to monitor received signal strength of the global communications network to which the the web radio interface is tuned; and to switch the device from a web radio reception mode to a broadcast radio reception mode, if the monitored received signal strength of the global communications network drops below a third limit.

The device may be a portable computer, a mobile telephone, a pager, a communicator, a smart phone, or an electronic organiser.

### BRIEF DESCRIPTION OF THE DRAWINGS

The invention will be described in detail below with reference to the accompanying drawings, in which:

FIG. 1 is a schematic diagram of an embodiment of the invention, and

FIG. 2 is a flow diagram of an embodiment of the procedure of the invention.

### DETAILED DESCRIPTION OF PREFERRED EMBODIMENTS

The invention is described with reference to a combined broadcast and web radio implemented in a handheld device, e.g. a telecommunication device such as a portable computer, a mobile telephone, a pager, a communicator, a smart phone, or an electronic organiser.

A broadcast radio receiver and a web access interface are controlled by a processor and software, and may be implemented by conventional components. The novelty of the invention resides basically in the handover function between the combined broadcast and web radio.

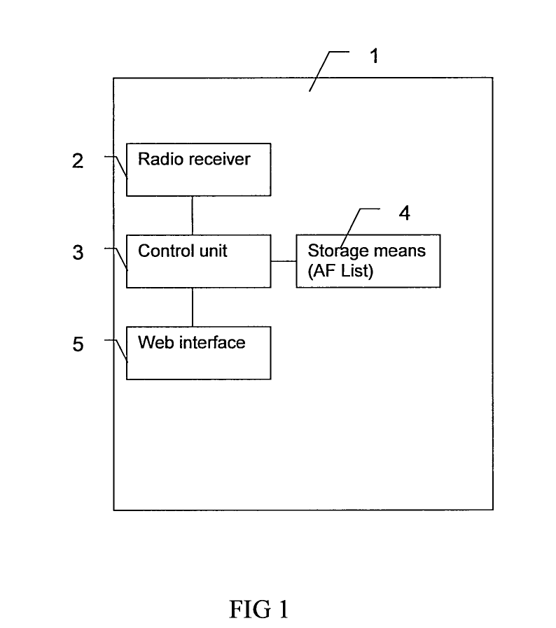

A schematic representation of a telecommunication device 1 is shown in FIG. 1. The device comprises a radio telecommunication interface and a user interface with a display and a keyboard which may be conventional and are not described in detail here. The invention is also applicable in a stand alone radio. The device comprises a radio unit or receiver 2 adapted to receive a program on a broadcast radio frequency. Broadcast radio is usually frequency modulated, FM, but amplitude modulated, AM, and other systems are equally possible. Preferably, the radio receiver 2 is operating according to the RDS (Radio Data System) standard, and is capable of extracting control information from the received signal, such as an alternative frequency, AF, request and lists as discussed below.

A web interface 5 forms part of the radio telecommunication interface as may be conventional, and is capable of establishing access to a global communications network, typically the Internet. A web radio station is located by means of a defined url, Uniform Resource Locator, or via a web page, and a streaming session may be established for streaming down content, such as a radio program.

A control unit 3 is capable of controlling the radio receiver 2 and the web interface 5 on the basis of user commands and software among other things implementing the procedure according to invention. A storage means 4 cooperates with the control unit 3 to store useful data such as AF lists, and buffering streamed down content.

In an RDS (Radio Data System) an AF, Alternative Frequencies, list is sent to radio receivers tuned in to a program. The list of alternative frequencies give information on the various transmitters broadcasting the same program in the same or adjacent reception areas, and enable receivers equipped with a memory to store one or more lists to reduce the time for switching to another transmitter.

Furthermore, a PI, Program Identification, code is transmitted together with the program on the channel. This information consists of a code enabling the receiver to distinguish between countries or areas in which the same program is transmitted, and the identification of the program itself. The code is not intended for direct display and is assigned to each individual radio program, to enable it to be distinguished from all other programs. One important application of this information is to enable the receiver to search automatically for an alternative frequency in case of bad reception of the program to which the receiver is tuned; the criteria for the change-over to the new frequency would be the presence of a better signal having the same Program Identification code.

As noted in the introduction, a problem with a portable device is that the received signal strength may fluctuate when the device is moving. In RDS, when the radio senses a low signal this triggers a search for a better channel with the same program.

According to RDS standard, the received signal strength is monitored continuously by the radio unit 2. A search for a better channel with the same program is triggered by an AF (Alternative Frequency) request, typically resulting from a measurement of a received signal strength RSSI (Received Signal Strength Indication) having a value below a predetermined threshold. The AF search searches for a different AF frequency having a greater received signal strength then the original frequency and transmitting the same program as identified with the Program Identification code PI.

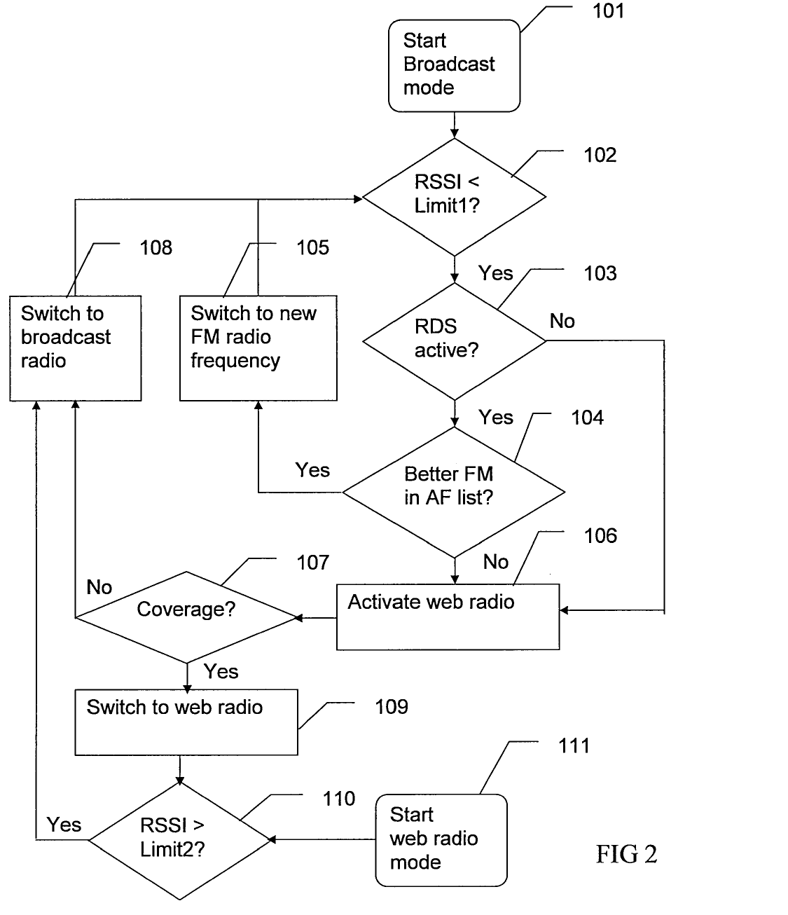

A diagram of a handover procudure according to an embodiment of the invention is shown in FIG. 2.

We assume that the procedures start in broadcast mode, box 101. The radio receiver 2 is tuned to a program on a particular frequency.

The received signal strength on the broadcast frequency is monitored continuously or intermittently. If RDS is implemented, RSSI is compared to a first limit, limit 1. If RSSI drops below limit 1, a search for an alternative channel is started, box 102.

If the device is not provided with RDS or RDS is inactive, box 103, the web radio interface is activated, box 106.

If RDS is active, the AF list gone through until a new frequency is found with a received signal strength above a limit, typically the same limit as limit 1, box 104. The radio receiver 2 may be provided with two reception units so that a search for a new frequency may be performed while the user is listening to the original frequency, so that there is no interruption in the received program. If only one receiver is available, there will be a short interruption while a new frequency is found.

If a better FM frequency is found, the radio receiver 2 is switched to a new frequency, box 105.

If not, the web radio is activated, box 106.

The web interface 5 tries to establish a connection to the Internet. The telecommunication system is tested for coverage, box 107. If there is no coverage, the device is switched back to broadcast radio, box 108. In this case the radio receiver 2 is still tuned to the original, possibly still poor, frequency.

If there is coverage, the device is switched to web radio, box 109. Suitably, if RDS is active, a URL is included in an extended AFlist. Another way could be to put the streaming URL as part of the Radio Text (RT) defined within the RDS standard. Thus, the control unit 3 immediately can access a correct web page containing the desired program and start to stream down the program. Suitably, the radio station providing the program both in a broadcast radio and as web radio, includes the url in the AFlist together with any FM alternative frequencies. If RDS is not active or provided, the user may be presented with a list on the display showing alternative available radio programs.

However, as noted in the introduction, web access is normally not free and more power consuming than an FM radio receiver. Thus, suitably the original FM frequency is still monitored with the radio receiver 2. If the received signal strength RSSI rises above a limit, the device will switch back to broadcast radio, again box 110. Limit2 may be set higher than Limit1 so as to avoid frequent handovers.

If the coverage is bad or lost, this may result in digital distortion, often experienced as short interruptions. The coverage is monitored continuously. If the coverage is lost, that is, if the monitored received signal strength of the global communications network drops below a limit, Limit3, the device is switched to broadcast radio, box 108.

It will be appreciated that the procedure may start in web radio mode, box 111, as selected by the user.

As is known, streaming is associated with delays. The streaming sender performs buffering and coding before streaming down content. Also in the receiver the streamed down content is stored in a buffer before decoding and presenting the content, in case of radio as sounds processed trough an audio player included in the device. The delay introduced by the sender is larger than introduced by the receiver, and also depends on choices made by the operator operating the sender.

Thus, when performing a handover from broadcast radio to web radio, there is a time delay, experienced by the listener possibly as a small interruption and then a repetition of a small portion of the program. When performing a handover from web radio to broadcast radio, on the other hand, a small portion of the program will be missing, corresponding to the time delay. For this reason, handovers should not be made too frequently. A timer may be introduced blocking handovers for a time interval. Also, a corresponding time delay may be introduced in the broadcast radio, by storing the received FM program in a buffer and presenting the audio content after a suitable time delay.

The invention may be implemented by means of suitable combinations of hardware and software. The scope of the invention is only limited by the claims below.

1. A portable device comprising: a radio receiver tunable to broadcast radio frequencies;
a web radio interface adapted to access radio stations through a global communications network;
a control unit capable of controlling the radio receiver and the web radio interface and adapted to monitor received signal strength on the radio receiver;
wherein the control unit is adapted to switch the device from a broadcast radio reception mode to a web radio reception mode, if the monitored received signal strength of the broadcast radio drops below a first limit.

2. A portable device according to claim 1, wherein, if the monitored received signal strength drops below said first limit, the control unit is adapted to perform a search for a better broadcast radio channel frequency than an original frequency with a program matching the broadcast radio original frequency, before switching the device from a broadcast radio reception mode to a web radio reception mode.

3. A portable device according to claim 2, further comprising storage means for receiving and storing a list of alternative frequencies;
wherein the control unit is adapted to perform next search using the list of alternative frequencies.

4. A portable device according to claim 3, wherein the control unit is adapted to use a url address for web access in the web radio reception mode, the url being included in the list of alternative frequencies.

5. A portable device according to claim 3, wherein the control unit is adapted to use a url address for web access in the web radio reception mode, the url being included as part of the Radio Text (RT) defined within the RDS standard.

6. A portable device according to claim 1, the control unit is adapted to switch the device from a web radio reception mode to a broadcast radio reception mode, if the monitored received signal strength of the broadcast radio rises above a second limit.

7. A portable device according to claim 1, wherein the control unit is adapted to monitor received signal strength of the global communications network to which the the web radio interface is tuned; and to switch the device from a web radio reception mode to a broadcast radio reception mode, if the monitored received signal strength of the global communications network drops below a third limit.

8. A portable device according to claim 1, wherein the device is a portable computer, a mobile telephone, a pager, a communicator, a smart phone, or an electronic organiser.
